(19) United States
(12) Patent Application Publication
(10) Pub. No.: US 2014/0246869 A1
(43) Pub. Date: Sep. 4, 2014

(54) DOOR HANDLE STRUCTURE FOR AN ENTRANCE/EXIT DOOR

(71) Applicant: Hyo Bin Yim, Seoul (KR)

(72) Inventor: Hyo Bin Yim, Seoul (KR)

(21) Appl. No.: 14/239,262

(22) PCT Filed: Jul. 24, 2012
(86) PCT No.: PCT/KR2012/005884

§ 371 Date: Feb. 18, 2014

(30) Foreign Application Priority Data
Aug. 18, 2011 (KR) 20-2011-0007475

(51) Int. Cl. E05B 5/00

(52) U.S. Cl. CPC E05B 5/00
USPC 292/164

(57) ABSTRACT

According to the present disclosure, a door handle structure for an entrance/exit door is configured such that a door handle does not protrude from the entrance/exit door to thereby prevent injuries to children or adults caused by collisions against it, prevent clothing from becoming caught in and torn by it, and lengthen the service life of the product by preventing collisions. Further, the door handle structure uses a reduced number of parts, thereby reducing manufacturing costs and improving durability. The door handle structure of the present invention has no protruding portion, thereby preventing a nearby wall from being damaged by a collision of the door handle against the nearby wall, eliminating the necessity of management of the wall and thereby maintaining the cleanliness of the wall. The service life of the door handle structure is lengthened by preventing collisions of the door handle against the wall.

### CROSS-REFERENCE TO RELATED APPLICATION

This application claims the benefit of Korean Patent Application No. 20-2011-0007475, filed on Aug. 18, 2011 in the Korean Intellectual Property Office, the disclosure of which is incorporated herein by reference.

### TECHNICAL FIELD

The present invention relates to a door handle structure for an entrance/exit door, and more particularly, to a door handle structure for an entrance/exit door with which it is possible to prevent user's dress from being ripped by being caught in a door handle since the door handle is provided at a front door, a room door or an entrance/exit door of an office to open or close the entrance/exit door and the door handle does not protrude from the entrance/exit door, it is possible to allow visitors or residents to safely use the door handle since children do not collide with a protrusion, it is possible to reduce manufacturing cost with a simple operating configuration, it is possible to cheaply replace the protruding door handle, a wall surface is not damaged even though the door handle collides with an adjacent wall surface since there is no protrusion, it is possible to cleanly maintain the wall surface since it is not necessary to manage the wall surface, and it is possible to lengthen a service life since there is not collision with the wall surface.

### BACKGROUND ART

In general, since a door handle provided at an entrance/exit door is provided such that a handle necessarily protrudes frontward from the entrance/exit door, a position of the door handle is positioned at the middle of the entrance/exit door at which adults hold the door handle with their hands. Thus, since the door handle is positioned at the same height as heads and shoulders of children, inattentive children hit their heads or their body on the door handle, so that the children may be frequently injured.

Further, due to a protrusion of the door handle, their dresses are caught in the protrusion sometimes, the dresses may be ripped and damaged.

In addition, since conventional door handles are manufactured using a large number of components, manufacturing cost may be increased. Since the door handle is frequently broken due to the large number of components, the door handle may be frequently replaced. Since it is expensive to replace the broken door handle, the broken door handle is used as it is, so that a secondary problem such as an ill appearance may be caused.

Moreover, since the conventional door handle has the protrusion, when the entrance/exit door is open or closed, the protrusion of the door handle collides with an adjacent wall, so that wall paper of the wall may be damaged. Further, since the inside of the door handle including the large number of components is easily damaged due to the colliding with the wall, a service life of the door handle is reduced, so that the door handle may not be used for a long time.

### DISCLOSURE

### Technical Problem

In order to solve the problems, an object of the present invention is to provide a door handle structure for an entrance/exit door with which since a door handle does not protrude from an entrance/exit door, it is possible to prevent children or adults from being injured by hitting their body on the door handle, it is possible to prevent their dresses from being damaged or ripped by being caught in the door handle, it is possible to lengthen a service life of a product by preventing the hitting, it is possible to reduce manufacturing cost by reducing the number of components, and it is possible to improve the durability of the product. Further, in the door handle structure for an entrance/exit door, since there is no protrusion, a wall surface is not damaged even though the door handle collides with an adjacent wall surface. Thus, it is not necessary to manage the wall surface, so that the wall surface can be cleanly maintained. In addition, since there is not collision with the wall surface, the service life of the door handle structure can be lengthened.

### Technical Solution

In order to achieve the above object, an exemplary embodiment of the present invention provides a door handle structure for an entrance/exit door according to the present invention includes a rod-shaped latch bolt that is disposed to be able to reciprocate back and forth and in which a locking part inserted into an insertion groove of a door frame is formed at one end thereof and an operating part that allows the latch bolt to reciprocate is formed at the other end thereof; a latch bolt holder that is disposed to be supported by a spring so as to allow the latch bolt to reciprocate and surrounds the latch bolt; latch pins that are provided at the operating part provided at a rear end of the latch bolt to protrude in an up and down direction; a pair of flap accommodating parts that is fixed to the front side and the rear side of the entrance/exit door with the latch bolt interposed therebetween and is provided grooves in which door flaps are accommodated; and a pair of door flaps that is hinge-fixed to the grooves of the flap accommodating parts, has operation bars extending from the door flaps to come in contact with the latch pins provided at the rear of the latch bolt and is elastically supported by springs.

### Effect of the Invention

A door handle structure for an entrance/exit door according to the present invention includes a rod-shaped latch bolt that is disposed to be able to reciprocate back and forth and in which a locking part inserted into an insertion groove of a door frame is formed at one end thereof and an operating part that allows the latch bolt to reciprocate is formed at the other end thereof; a latch bolt holder that is disposed to be supported by a spring so as to allow the latch bolt to reciprocate and surrounds the latch bolt; latch pins that are provided at the operating part provided at a rear end of the latch bolt to protrude in an up and down direction; a pair of flap accommodating parts that is fixed to the front side and the rear side of the entrance/exit door with the latch bolt interposed therebetween and is provided grooves in which door flaps are accommodated; and a pair of door flaps that is hinge-fixed to the grooves of the flap accommodating parts, has operation bars extending from the door flaps to come in contact with the latch pins provided at the rear of the latch bolt and is elastically supported by springs. Accordingly, since the door flaps do not protrude from the entrance/exit door, it is possible to prevent children or adults from being injured by hitting their body on the door flaps, and it is possible to prevent their dresses from being damaged or ripped by being caught in the door flaps. Further, it is possible to lengthen a service life of a product by preventing the hitting, it is possible to reduce manufacturing cost by reducing the number of components, and it is possible to improve the durability of the product. Since there is no protrusion, a wall surface is not damaged even though the door handle collides with an adjacent wall surface. Thus, it is not necessary to manage the wall surface, so that the wall surface can be cleanly maintained. In addition, since there is not collision with the wall surface, the service life of the door handle structure can be lengthened.

### DESCRIPTION OF DRAWINGS

FIG. 1 is a perspective view of a door provided with a door handle structure for an entrance/exit door according to a first embodiment of the present invention.

FIG. 2 is a perspective view of the door handle structure for an entrance/exit door according to the first embodiment of the present invention.

FIG. 3 is a cross-sectional view illustrating a case where the door handle structure for an entrance/exit door according to the first embodiment of the present invention is provided at the door.

FIG. 4 is a cross-sectional view illustrating a case where the door handle structure for an entrance/exit door according to the first embodiment of the present invention is open.

FIG. 5 is a perspective view of a latch bolt used in the door handle structure for an entrance/exit door according to the first embodiment of the present invention.

FIG. 6 is a perspective view of the latch bolt holder used in the door handle structure for an entrance/exit door according to the first embodiment of the present invention.

### BEST MODE

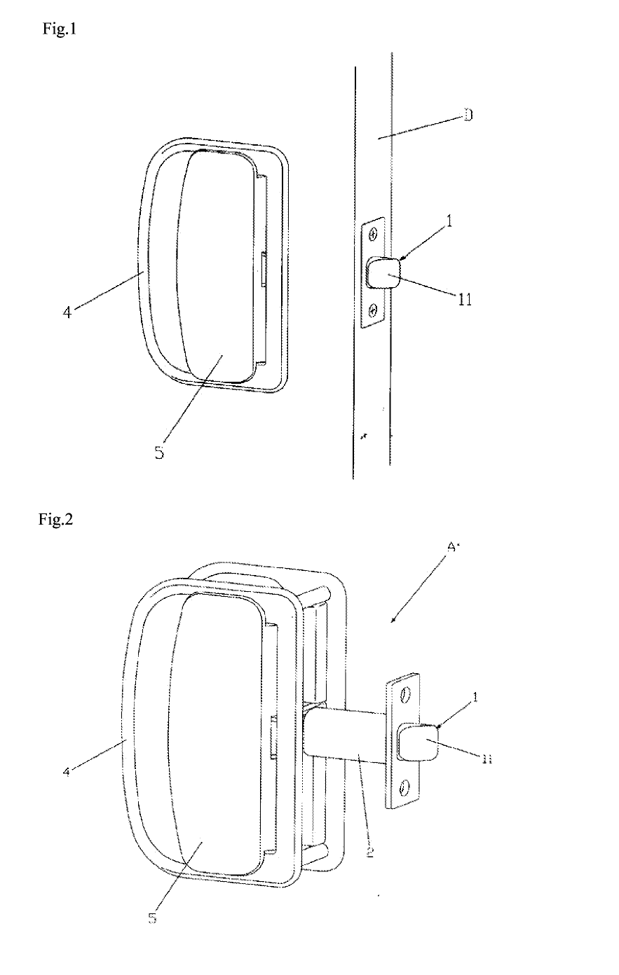

As shown in FIG. 1, a door handle structure A for an entrance/exit door according to a first embodiment of the present invention is provided at an entrance/exit door D. In the door handle structure, a door handle including a flap accommodating part and a door flap that are provided at a front side and a rear side of the entrance/exit door D is exposed, but the door flap of the door handle that opens or closes the entrance/exit door D is provided so as not to protrude from the entrance/exit door.

As shown in FIG. 2, the door handle structure A includes a rod-shaped latch bolt 1 that is disposed to be able to reciprocate back and forth and in which a locking part 11 inserted into an insertion groove D1a of a door frame D1 is formed at one end thereof and an operating part 12 that allows the latch bolt to reciprocate is formed at the other end thereof; a latch bolt holder 2 that is disposed to be supported by a spring 21 so as to allow the latch bolt 1 to reciprocate and surrounds the latch bolt 1; latch pins 3 that are provided at the operating part 12 provided at a rear end of the latch bolt 1 to protrude in an up and down direction; a pair of flap accommodating parts 4 that is fixed to the front side and the rear side of the entrance/exit door D with the latch bolt 1 interposed therebetween and is provided grooves 41 in which door flaps are accommodated; and a pair of door flaps 5 that is hinge-fixed to the grooves 41 of the flap accommodating parts 4, has operation bars 51 extending from the door flaps to come in contact with the latch pins 3 provided at the rear of the latch bolt 1 and is elastically supported by springs 52.

As shown in FIG. 5, in the latch bolt 1, a stopper 13 is formed to be space apart from the locking part 11 at a certain distance to support one end of the spring 21, and the latch pins 3 are inserted into and fixed to the operating part 12.

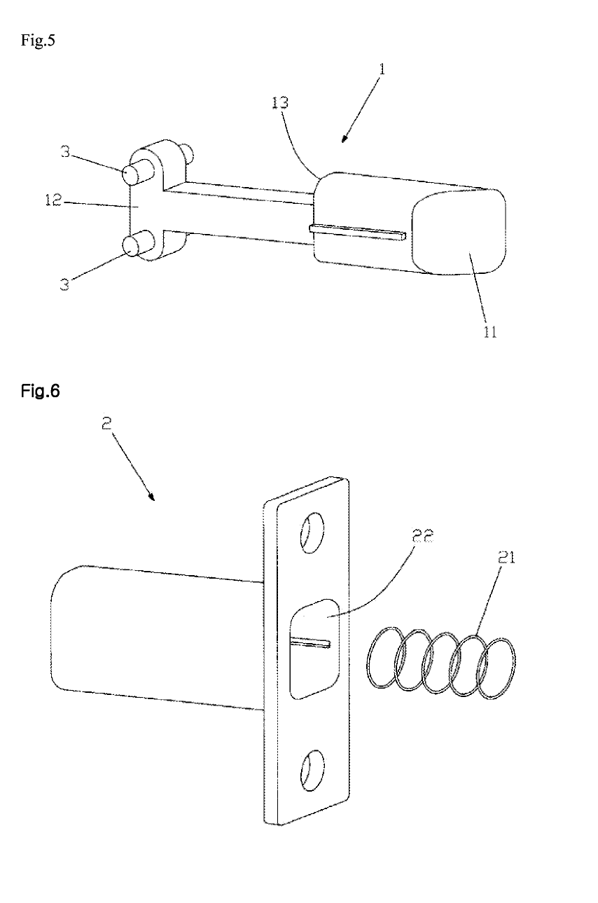

As shown in FIG. 6, an insertion hole 22 into which the latch bolt 1 is inserted and a supporting part 23 for supporting the one end of the spring 21 are formed within the latch bolt holder 2, and, thus, the latch bolt 1 is elastically supported by the spring 21 to allow the latch bolt to reciprocate.

Since two latch pins 3 are inserted into and fixed to the operating part 12 of the latch bolt 1, both ends of the latch pins are fixed to protrude from the operating part, and, thus, four protrusions are total formed at the two latch pins 3 in total. The operating bars 51 of the door flaps 5 are fixed to come in contact with the latch pins 3 such that the operating bars press the latch pins 3 to allow the latch bolt 1 to reciprocate back and forth. In the present embodiment, although it has been described that the latch pins 3 are inserted into and fixed to the operating part, the latch pins may be integrally formed at the latch bolt 1 to protrude.

Since the grooves 41 are formed at the flap accommodating parts 4, the door flaps 5 are positioned within the grooves 41, and the door flaps 5 are hinge-fixed by hinge shafts 42 to be hinge-operated. Penetrating holes 43 through which the operating bars 51 of the door flaps 5 penetrate are formed in portions of the flap accommodating parts 4 close to the latch bolt 1, so that the door flaps 5 are hinge-fixed within the grooves 41 of the flap accommodating parts 4.

The door flaps 5 are disposed such that the operating bars 51 are hung on the latch pins 3 through the penetrating holes 43 of the flap accommodating parts 4. In this state, one ends of the door flaps 5 are hinge-fixed to the flap accommodating parts 4 by the hinge shafts 42. The other ends of the door flaps 5 are provided as free ends to allow the hinge-fixed portions to rotate around the hinge shafts 42, and are fixed to be pulled toward the grooves 41 of the flap accommodating parts 4 by the springs 52. The springs 52 are provided as pin springs and are elastically supported such that the door flaps 5 are closely pulled toward the grooves 41 of the flap accommodating parts 4.

An operation of the door handle structure A for an entrance/exit door according to the present invention having the aforementioned configuration will be described below. Since the door flaps 5 are closely hinge-fixed to the flap accommodating parts 4, it is possible to prevent a user from hitting his or her body on the door flaps 5 or his or her dress from being caught in the door flaps. Further, even though the user hits his or her body on the door flaps 5, since there is no protrusion, it is just similar to hitting against the wall, and it is possible to prevent the user from being seriously injured.

As described above, while the door flaps 5 are closely hinge-fixed to the flap accommodating parts 4, when the door flaps 5 are pulled to open the door, since the door flaps 5 rotate, the operating bars 51 connected to the door flaps 5 push the latch pins 3. Accordingly, since the latch bolt 1 is moved backwards, the locking part 11 of the latch bolt 1 is separated from the insertion groove D1a of the door frame D1, and, thus, the entrance/exit D can be open. After the entrance/exit D is open, when the door flaps 5 are released, the door flaps 5 are returned to positions close to the flap accommodating parts 4 due to elastic restoring force of the springs 52.

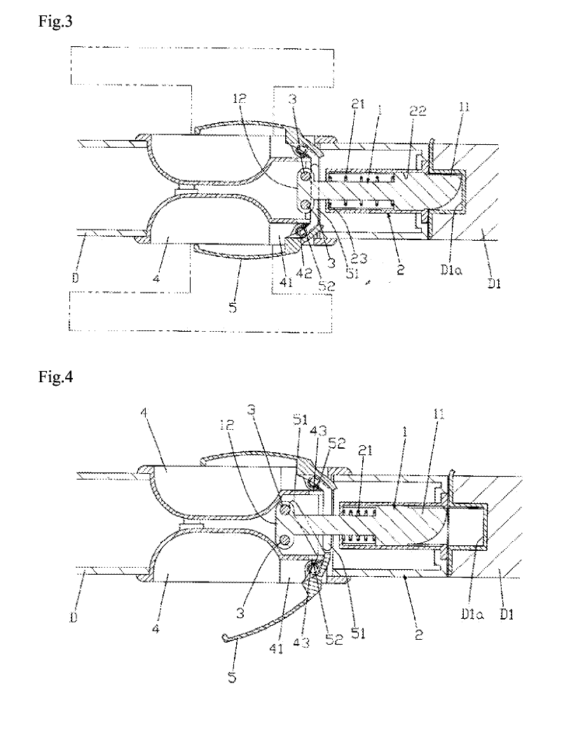

As stated above, as shown in FIG. 3, since the door flaps 5 are closely hinge-fixed to the flap accommodating pats 4 and the door flaps 5 are pulled within the grooves 41 of the flap accommodating parts 4 by the user's hand, the door handle structure A for an entrance/exit according to the first embodiment of the present invention has no protrusion, unlike the conventional protruding door handle depicted by a dashed double-dotted line of FIG. 3. Accordingly, since the door flaps do not protrude from the entrance/exit door, it is possible to prevent children or adults from being injured by hitting their body on the door flaps, and it is possible to prevent their dresses from being damaged or ripped by being caught in the door flaps. Further, it is possible to lengthen a service life of a product by preventing the hitting, and it is possible to reduce manufacturing cost by reducing the number of components.

Moreover, since the door flaps 5 do not protrude outwards from the entrance/exit door D, it is possible to prevent a wall (not shown) with which the entrance/exit door D collides from being damaged, so that an outer surface of the wall can be cleanly maintained. In addition, it is possible to prevent the damage due to the colliding of the door handle structure A for an entrance/exit door, so that the service life of the door handle structure can be lengthened.

### INDUSTRIAL APPLICABILITY

Since the door handle structure for an entrance/exit according to the present invention can be repeatedly manufactured in a general door lock manufacturer, the present invention has industrial applicability.

1. A door handle structure (A),
wherein the door handle structure (A) includes:
a rod-shaped latch bolt (1) that is disposed to be able to reciprocate back and forth and in which a locking part (11) inserted into an insertion groove (D1a) of a door frame (D1) is formed at one end thereof and an operating part (12) that allows the latch bolt to reciprocate is formed at the other end thereof;
a latch bolt holder (2) that is disposed to be supported by a spring (21) so as to allow the latch bolt (1) to reciprocate and surrounds the latch bolt (1);
latch pins (3) that are provided at the operating part (12) provided at a rear end of the latch bolt (1) to protrude in an up and down direction;
a pair of flap accommodating parts (4) that is fixed to the front side and the rear side of the entrance/exit door (D) with the latch bolt (1) interposed therebetween and is provided grooves (41) in which door flaps are accommodated; and
a pair of door flaps (5) that is hinge-fixed to the grooves (41) of the flap accommodating parts (4), has operation bars (51) extending from the door flaps to come in contact with the latch pins (3) provided at the rear of the latch bolt (1) and is elastically supported by springs (52).

2. The door handle structure (A) of claim 1,
wherein in the latch bolt (1), a stopper (13) is formed to be space apart from the locking part (11) at a predetermined distance to support one end of the spring (21), and the latch pins (3) are inserted into and fixed to the operating part (12).

3. A door handle structure (A) provided with a latch bolt (1),
wherein in the latch bolt (1), a stopper (13) is formed to be space apart from the locking part (11) at a predetermined distance to support one end of the spring (21), and the latch pins (3) are inserted into and fixed to the operating part (12).
